(19) United States
(12) Patent Application Publication
(10) Pub. No.: US 2023/0059202 A1
(43) Pub. Date: Feb. 23, 2023

(54) METHOD FOR THE DYNAMIC TESTING OF DENTAL PROSTHESES, AND SYSTEM FOR CARRYING OUT SAID METHOD

(71) Applicants: Giuseppe Rampulla, Tizzano Val Parma (IT); Luca Pighin, Zoppola (IT)

(72) Inventors: Giuseppe Rampulla, Tizzano Val Parma (IT); Luca Pighin, Zoppola (IT)

(21) Appl. No.: 17/796,709

(22) PCT Filed: Jan. 31, 2021
(86) PCT No.: PCT/IB2021/050758

§ 371 Date: Aug. 1, 2022

(30) Foreign Application Priority Data
Jan. 31, 2020 (IT) 102020000001981

(51) Int. Cl. A61C 11/08; A61C 13/34; A61C 13/00

(52) U.S. Cl. CPC A61C 11/08; A61C 13/0004; A61C 13/34

(57) ABSTRACT

Reciprocal positions of negative casts (2, 3) upper and lower dental arches, of a subject (S) recipient of a dental prosthesis (1), by means of an attitude detection device (40).

These positions are then transferred to a manual articulator (50) to be able to positionpositive models (20, 30) of the same upper and lower dental arches with a dentation model form for a dental prosthesis (1).

Using a column template (6), (50) adjustments are detected and brought back to an articulator robot (90), operated by actuators (94).

Chewing movements of the subject (S) are video-taped and digitized, so that a program generator (80) provdes a sequence of commands for driving the robot to move the models (20, 30) to replicate mandibular movements of the subject (S) so as to enable evaluation of correctness of the dentation model form, and possibly modify.

### TECHNICAL FIELD

The present invention belongs to the technical sector relating to dental technology and dentistry, and more precisely to the construction and testing of dental prostheses.

In particular, the present invention consists of a method, and a corresponding system, for detecting the masticatory dynamics of a subject who needs a dental prosthesis, and for the verification of the prosthesis made for that subject on the basis of the masticatory dynamics detected.

### BACKGROUND ART

In dental technology, the procedures for making a dental prosthesis for a subject are almost standardized, often involving, as a first step, the taking of a negative cast of one or both of the dental arches of the latter.

From the negative casts, relative positive models are then obtained using resins or gypsum, in which there is the space/s in which to insert the prosthesis.

The prosthesis thus created usually reproduces the desired shape and dimensions with good approximation so that it fits perfectly into the space left free in the dental arch of the subject for which it is intended, but it needs adjustments in order to be able to adequately replace the missing portion of teeth.

These adjustments, still today, are often carried out through repeated direct tests on the recipient of the prosthesis at the dentist’s office, with the collaboration of the dental technician present, who makes the adjustments until a well-sized and positioned prosthesis is obtained, and that the subject feels correct.

A more modern methodology provides for the assembly of the prosthesis and the model reproduced starting from the cast on a so-called “mechanical articulator”, which consists of an articulated structure capable of accommodating the lower and upper arches of the model; one of the supports of the arches, usually the upper one, is made mobile with respect to the lower one, and in particular hinged to it, according to a direction of mutual approach and departure, to simulate the relative movements of one dental arch with respect to the other.

The movement is carried out manually to check the correct occlusion of the two dental arches with the prosthesis inserted, and to make the necessary, and progressive, adjustments.

### Technical Problem

Although the fidelity of the shapes of the dental arch models has become high, the checks and simulations that can be carried out using the mechanical articulator are necessarily based on standard facial movements, limited by the kinematics of the hinge joint of the articulator.

Basically, in the aforementioned tests there is no correspondence with the real chewing movements of the recipient of the prosthesis, which are always different from those of all the others, due to the always different morphologies of the skull and jaw, the structure (and possible asymmetries or other defects) of the mandibular joints of the individual, the consistency and symmetry of the muscle bundles that control them, etc.

To overcome these limits, which make the tests of the prostheses not perfectly respond to the real situation of when the same will be found in the mouth of the subject, the same Applicant filed the patent application for industrial invention N° 102017000110539 on Mar. 10, 2017, entitled “Method for the dynamic testing of dental prostheses, and system for carrying out said method”.

In the document just referred to, a method for verifying dental prostheses is protected, which envisages the use of an articulator robot to faithfully simulate the personal chewing movements of each subject to whom the prosthesis is intended, after said chewing movements have been detected by taking images, processed electronically to create a program suitable for appropriately driving the aforementioned articulator robot, on which a model of the dentition of that subject and the prosthesis made for it are mounted.

With the implementation of the aforementioned method, considerable progress has been made in terms of correspondence between the test conditions of the prosthesis on the articulator robot and the real ones in the patient’s mouth, compared to when only a manual mechanical articulator is used.

However, in practical situations of use, with different subjects, some limitations have emerged regarding the detection phases of chewing movements, which are complex and combined and therefore require a better procedure to obtain greater accuracy and completeness of the acquired data.

The latter, then, represent the essential basis for being able to subsequently replicate the movements by means of suitable commands of the articulator robot.

### Objects of the Invention

The purpose of the present invention is therefore to propose a method for the dynamic testing of dental prostheses that allows the positional relationship between the dental arches of the subject to be detected in a very accurate way, and then to report said positional relationship exactly between the models of the same dental arches, with the prosthesis, in the assembly phase in an articulator robot, then to acquire three-dimensional parameters relating to all the possible chewing movements of the same subject, so as to be able to command said articulator robot to faithfully replicate said chewing movements and verify the behavior of the dental prosthesis itself.

Another object of the invention is to provide tools necessary or useful for carrying out the detection of the aforementioned positional relationship between the dental arches of the subject.

A further purpose of the invention is to provide suitable tools for the acquisition of the aforementioned three-dimensional parameters relating to the personal chewing movements of the recipient of the prosthesis.

### SUMMARY OF THE INVENTION

The aforementioned purposes are fully achieved by means of a method for the dynamic testing of dental prostheses, and by a system that implements it, where one of said dental prostheses is intended to be implanted in a recipient subject, for which a model has been made of dentition comprising a model of an upper dental arch and a model of a lower dental arch, with each of said models obtained starting from respective negative casts of said upper and lower dental arches.

The method involves the following operational steps:
1) application to said negative casts of the upper and lower dental arches of relative bases provided with a predetermined external attachment fork;
2) assembly of the base with a negative cast of the upper dental arch, using the relative fork, in an attitude detection device;
3) introduction of said base with a negative cast of the upper dental arch into the oral cavity of the aforementioned subject, with the head of the latter placed in a predetermined position and with said device for detecting the structure protruding from the outside of the mouth;
4) acquisition, by means of said attitude detection device, of the angular values of inclination of the aforementioned negative cast of the upper dental arch and therefore of the upper dental arch itself, or of the jaw, of the aforementioned subject;
5) extraction from the oral cavity of the aforementioned subject of said base with negative cast of the upper dental arch with adjoining device for detecting the attitude;
6) assembly of the base complex with a negative cast of the upper dental arch and a trim detection device in a manual articulator;
7) coupling of the aforementioned negative cast of the upper dental arch with the respective model of the upper dental arch and the addition of the filling material necessary to close the space between the same model of the upper dental arch and a corresponding bracket of said manual articulator;
8) removal from the latter of the base complex with a negative cast of the upper dental arch and a device for detecting the attitude and disassembly of the same base with a negative cast of the upper dental arch;
9) repetition of steps 2) to 8) using the aforementioned base with a negative cast of the lower dental arch;
10)assembly on said manual articulator of an extensible column template for detecting the configuration assumed as a consequence of the subsequent assembly of the aforementioned negative casts and models of said upper and lower dental arches;
11)use of the aforementioned extensible column template to record the configuration of an articulator robot in the same way as the aforementioned configuration of the manual articulator;
12)assembly on said articulator robot, thus registered, of the aforementioned models of said upper and lower dental arches, with at least one dental prosthesis applied to be tested;
13)acquisition and digitization of a predetermined sequence of chewing movements, on at least three reference axes, by means of video footage of the subject carried out with a suitable 3D scanner, with the same subject wearing positional reference means of the upper and lower dental arches, provided with respective upper and lower markers with at least three detection points, located outside the mouth;
14)digital processing of these shots with a program generator, to create a sequence of commands suitable for replicating the personalized mandibular movements of said subject;
15)actuation of the aforementioned articulator robot with said sequence of commands, to move the aforementioned models of said upper and lower dental arches, having applied at least one dental prosthesis to be tested, in perfect replication to the mandibular movements of the subject destined to receive the same prosthesis, so as to being able to evaluate the correctness of the shape of the dental prosthesis itself, and possibly modify it.

### BRIEF DESCRIPTION OF THE DRAWINGS

The characteristics of the invention will become evident from the following description of a method for the dynamic testing of dental prostheses, and a system for implementing this method, in accordance with what is proposed in the claims and with the aid of the attached drawing tables, in the which:

FIG. 1 illustrates, with a block diagram, the significant phases of the method and their correlation with accessory phases;

FIG. 2 shows a negative cast of a dental arch mounted on a base with an external attachment fork;

FIG. 3 illustrates the phase of the method relating to the acquisition of the position of the cast of FIG. 2 introduced into the oral cavity of the person concerned, by means of a buoyancy detection device applied externally using said attachment fork;

FIGS. 4A, 4B, 4C, 4C illustrate subsequent steps to mount the models of the upper and lower arches on a manual articulator with the positions measured by the attitude detection device;

FIG. 5 illustrates the phase of capturing video images relating to the subject’s chewing movements;

FIG. 6 illustrates the phase of detecting the final configuration assumed by the manual articulator using a column template;

FIG. 7 illustrates the initial placement of an articulator robot using the column template taken from the manual articulator;

FIGS. 8A, 8B illustrate two positions of the articulator robot, with the models of the dental arches and at least one prosthesis mounted, during the replication of the subject’s chewing movements.

### DESCRIPTION OF PREFERRED EMBODIMENTS OF THE INVENTION

In the above figures, the reference 100 indicates, as a whole, a system for the dynamic testing of a dental prosthesis 1 intended to be implanted in a recipient subject S, for which a dentition model has been made including an arch model upper dental arch 20 and a lower dental arch model 30, with each of said models 20, 30 obtained starting from respective negative casts 2, 3 of said upper and lower dental arches.

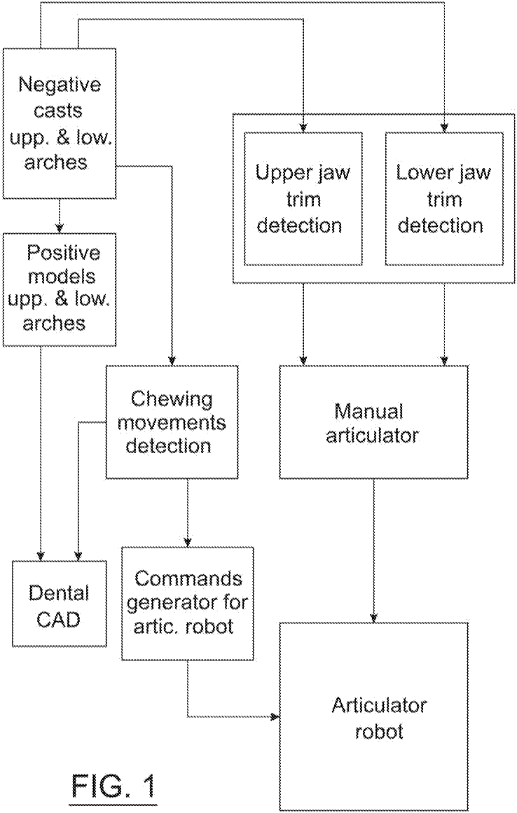

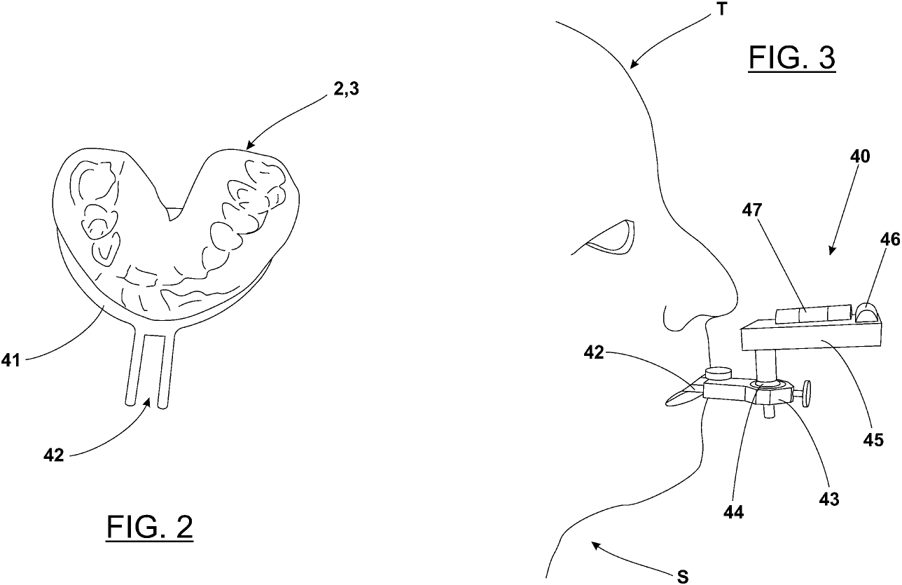

The system 100 is illustrated in the block diagram of FIG. 1 and comprises, among other things, an attitude detection device 40 in which are provided: at least two bases 41, each provided with an external attachment fork 42, intended to support said negative casts 2, 3 (FIG. 2) of the upper and lower dental arches.

Each base 41, with its relative negative cast 2, 3 is adapted to be introduced, one at a time, into the oral cavity of the aforementioned subject S, with the head T of the latter arranged in a predetermined position and with said device for detecting the structure 40 projecting in cantilever form outside the mouth (FIG. 3).

Each base 41 is removably associated, by means of the relative fork 42, to a block 43 to which, by means of a lockable ball joint 44, a reference tablet 45 on which two bubble levels 46, 47 are arranged, one perpendicular to the other, intended to display the reached horizontal position of the same reference tablet 45.

When the latter is correctly arranged horizontally, according to the two orthogonal planes controlled by the bubble levels 46, 47, its position, with respect to that of the respective negative cast 2, 3, is stabilized by locking said ball joint 44 .

The block 43 bearing fixed a base 41, with the relative negative cast 2, 3, is suitable for being mounted on a manual articulator 50, consisting of a fixed lower platform 51, substantially horizontal, to which an upper arm 52 is articulated in a lockable manner, arranged at a predetermined distance from said lower platform 51, and also practically horizontal.

For the aforementioned assembly, the spherical joint 44 is coupled to a rod 48 interposed between the fixed lower platform 51 and the upper arm 52, in a vertical position, orienting the base 41 and the relative cast in negative casts 2, 3, towards the inside of the manual articulator 50.

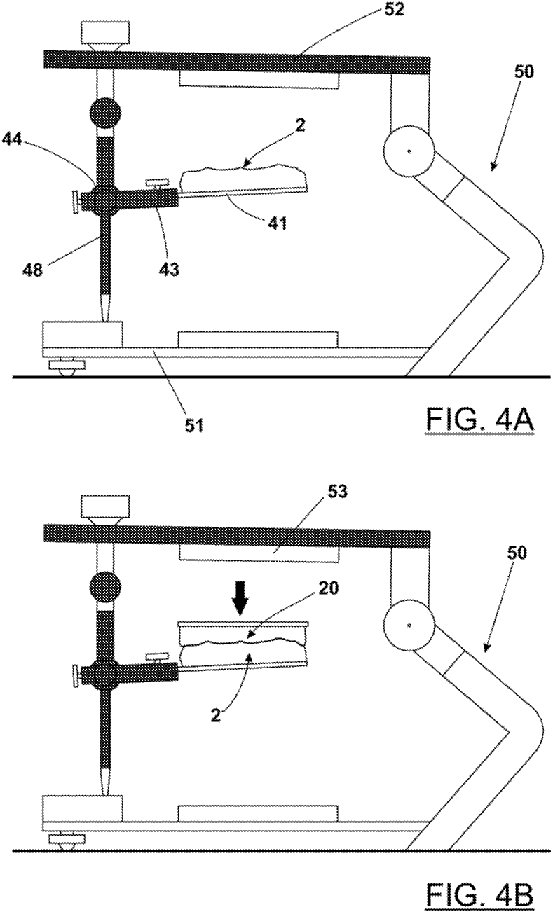

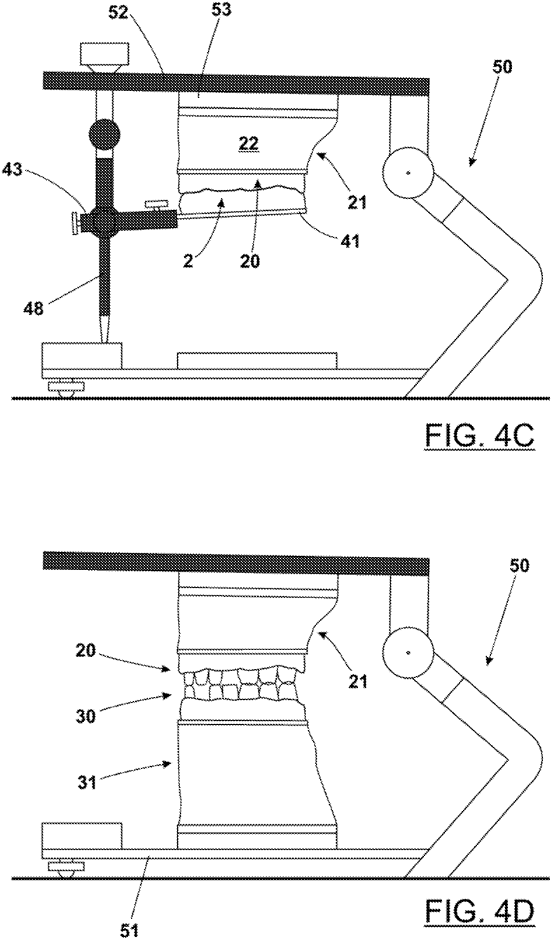

In particular, the assembly of the base 41 is first envisaged with the negative cast 2 of the upper dental arch (FIG. 4A), on which the corresponding model of the upper dental arch 20 (FIG. 4B) is placed to build, between the fixed lower platform 51 and upper arm 52, a support 21 of the same model 20, with the application of filler material 22 necessary to close the space between the same model 20 of the upper dental arch and a corresponding bracket 53 of said upper arm 52 (FIG. 4C).

With the same procedure, repeated with the negative cast 3 of the lower dental arch and then with the relative model 30 of the same, a support 31 is obtained for the latter and the reciprocal position between the models of the aforementioned upper 20 and lower 30 dental arches is reconstructed on the manual articulator 50, which reproduces the position in which the respective real dental arches of the aforementioned subject S are mutually in contact (FIG. 4D).

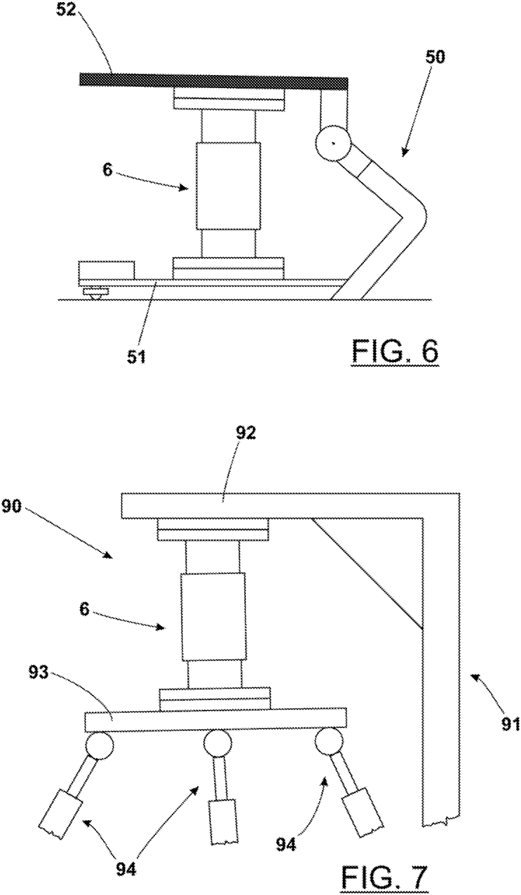

The distance and orientation assumed by the upper arm 52 with respect to the lower fixed platform 51 are detected, after the disassembly of the models 20, 30 with their respective supports 21, 31, by an extensible column template 6 (FIG. 6).

In the system 100 there are also means 70 for the acquisition and digitization of a predetermined sequence of chewing movements of the aforementioned subject S, on at least three reference axes.

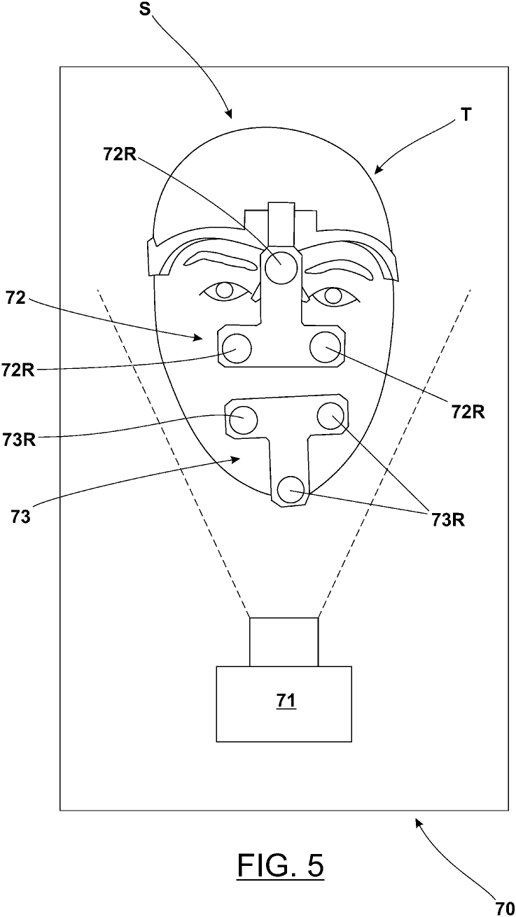

Said means 70 comprise a 3D scanner (of known type not shown), members 71 for video shooting of the subject S and positional reference means of the upper and lower dental arches; the latter, not visible in FIG. 5, are able to be introduced into the oral cavity of the subject S and to engage with his dental arches, so as to assume stable positions with respect to these.

The positional reference means are provided with respective upper 72 and lower 73 markers disposed externally to said oral cavity and each have at least three detection points 72R, 73R (see again FIG. 5).

Said means 70 are interfaced with a program generator 80, provided for the digital processing of said video recordings of the chewing movements, and to create a sequence of commands suitable for replicating the personalized mandibular movements of said subject S (FIG. 1).

The aforementioned extensible column template 6, disassembled from the manual articulator 50, is then used to statically record the starting position of a computer-controlled articulator robot 90 (FIG. 7).

In the articulator robot 90 there is a frame 91 from which an upper beam 92 protrudes, able to support, in a fixed hanging position, said model 20 of the upper dental arch, with the relative support 21, and a lower platform 93 above which said model 30 of the lower dental arch is fixed with the respective support 31.

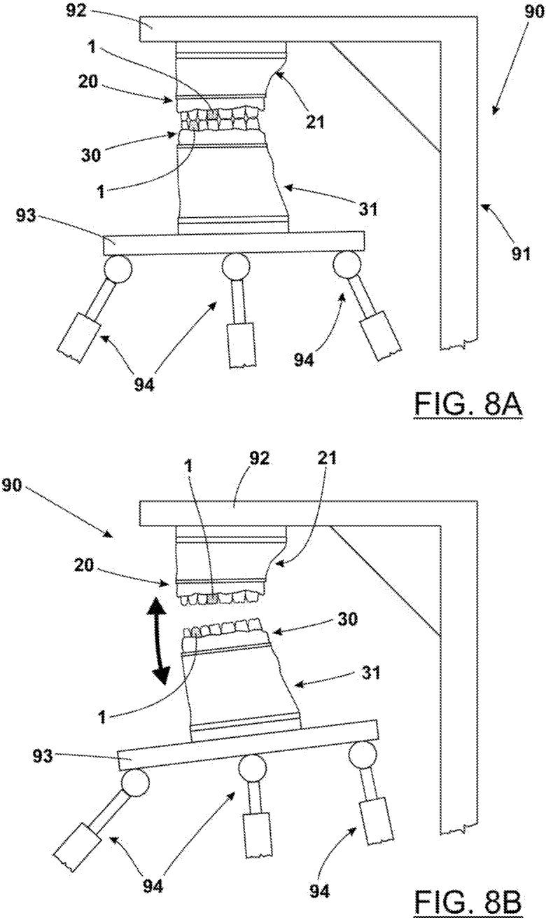

In said models 20, 30 at least one dental prosthesis 1 to be tested is applied (FIGS. 8A, 8B).

The lower platform 93 is associated with a plurality of linear actuators 94, suitably arranged and oriented, capable of moving the same lower platform 93, as well as the model 30 of the lower dental arch with multiple trajectories according to different planes (see in particular the FIG. 8B), said linear actuators 94 being driven by a sequence of commands supplied by the aforementioned program generator 80, to simulate predetermined chewing movements of said models 20, 30 of upper and lower dental arches, and of the at least one dental prosthesis 1 to test, in perfect replication of the mandibular movements of the subject S destined to receive the same at least one dental prosthesis 1.

The dental prosthesis 1 can therefore be verified exactly as if it had been directly applied to the mouth of the subject S, and therefore all the adjustments, measurements and modifications necessary to obtain a product directly applicable to the subject S can be made on it, so that direct tests on the latter are unnecessary, avoiding further modifications.

The system 100 just described effectively implements the method object of the present invention, for the dynamic testing of dental prostheses 1, of which at least one is intended to be implanted in a recipient S.

The main steps of the method, described below and also schematized in the diagram of FIG. 1, are preceded by known operations with which, for said subject S, a complete dentition model formed by a model 20 of an upper dental arch and a model 30 of a lower dental arch, with each of said models 20, 30 obtained starting from respective negative casts 2, 3 of said upper and lower dental arches.

A first version of the aforementioned at least one dental prosthesis 1 is also made in advance, to be applied to said models 20, 30 for testing and, after testing and any modifications, implanted in subject S.

In a first step of the method, said negative casts 2, 3 of the upper and lower dental arches are applied on relative bases 41, provided with a predetermined external attachment fork 42 (FIG. 2).

The second phase involves the assembly of the base 41 with a negative cast 2 of the upper dental arch, using the relative fork 42, in the attitude detection device 40 present in the system 100 previously described.

The third phase provides for the introduction of said base 41 with a negative cast 2 of the upper dental arch into the oral cavity of the aforementioned subject S, with the head T of the latter arranged in a predetermined position and with said device 40 for detecting the trim protruding in cantilever form outside the mouth (FIG. 3).

The head T of the subject S is preferably placed straight with the gaze turned to the horizon line.

The fourth phase involves the acquisition, by means of said attitude detection device 40, of the angular values of inclination of the aforementioned negative cast 2 of the upper dental arch and therefore of the upper dental arch itself, or of the jaw, of the aforementioned subject S (see again FIG. 3).

For the acquisition of the angular values of inclination of the dental arches of the subject S, first of the upper one, or of the maxilla, then of the lower one, or of the mandible, with a similar phase mentioned below, a reference tablet 45 provided in said attitude detection device 40 which is arranged horizontally, with the aid of bubble levels 46, 47.

The horizontal position reached is blocked and stabilized by tightening a ball joint 44, also provided in said attitude detection device 40.

The fifth phase involves the extraction from the oral cavity of the aforementioned subject S of said base 41 with a negative cast 2 of the upper dental arch with adjoining the attitude detection device 40.

The sixth phase involves the assembly of the base complex 41 with a negative cast 2 of the upper dental arch and the attitude detection device 40 in a manual articulator 50, present in the system 100 previously described (FIG. 4A).

The seventh phase involves the coupling of the aforementioned negative cast 2 of the upper dental arch with the respective model 20 of the upper dental arch (FIG. 4B) and the construction of a support 21 of the same model 20, with the application of material filler 22 necessary to close the space between the same upper dental arch model 20 and a corresponding bracket 53 of said manual articulator 50 (FIG. 4C).

The eighth phase involves the removal from the manual articulator 50 of the base complex 41 with a negative cast 2 of the upper dental arch and a trim detection device 40 and disassembly of the same base 41 with a negative cast 2 of the upper dental arch.

The phases from the second to the eighth are repeated using the remaining base 41 with a negative cast 3 of the lower dental arch, in order to obtain, on said manual articulator 50, also a support 31 for the model 30 of the lower dental arch.

In this way, on the manual articulator 50, the reciprocal position in which the models 20, 30 of the aforementioned upper and lower dental arches are mutually in contact is reconstructed, so as to reproduce the same position in which the respective real dental arches of the cited subject S (FIG. 4D).

Said models 20, 30 of the dental arches, with the relative supports 21, 31, are then disassembled from the manual articulator 50 and, without moving anything in the latter, a template with an extensible column 6 is mounted in their place, for detection of the configuration assumed as a consequence of the previous assembly (FIG. 6).

A subsequent phase involves the use of the aforementioned extensible column template 6 to record the static configuration of an articulator robot 90 in the same way as the aforementioned configuration assumed by the manual articulator 50 (FIG. 7).

A further step provides for the assembly on said articulator robot 90, thus registered, of the aforementioned models 20, 30 of said upper and lower dental arches, having applied at least one dental prosthesis 1 to be tested (FIG. 8A).

A phase carried out in parallel, provides for the acquisition and digitization of a predetermined sequence of chewing movements, on at least three reference axes, by means of video footage of the subject S carried out with a suitable 3D scanner, with the same subject S wearing reference means positional position of the upper and lower dental arches, provided with respective upper 72 and lower 73 markers with at least three detection points each 72R, 73R, arranged externally to the mouth (FIG. 5).

More precisely, the aforementioned upper markers 72, associated with the maxilla, are considered the fixed references, while the lower ones 73, associated with the mandible, are considered the movable references whose displacements are detected in relation to the positions of said fixed references.

Following the phase just described, another is planned which involves the digital processing of said shots with a program generator 80, to create a sequence of commands suitable for replicating the personalized mandibular movements of said subject S.

As a last step of the method, the aforementioned articulator robot 90 is operated with said sequence of commands, to move the aforementioned models 20, 30 of said upper and lower dental arches, with at least one dental prosthesis 1 to be tested applied, in perfect replica of the mandibular movements of the subject S destined to receive the same prosthesis 1, so as to be able to evaluate the correctness of the shape of the same dental prosthesis 1, and possibly modify it.

An optional phase of the method, even if known and not relevant for the purposes of the aforementioned peculiar phases, provides for detecting the three-dimensional mathematics of said upper and lower dental arch models 20, 30, including at least one dental prosthesis 1, and loading them in a software program of a dental CAD 10.

The digitized data of said predetermined sequence of chewing movements, on at least three reference axes, acquired by means of said video recordings of the subject S wearing positional reference means, is also loaded into the same software program of the dental CAD 10.

Finally, we proceed to interface, by means of said software program, said three-dimensional mathematics with the aforementioned digitized data of the sequence of chewing movements, to obtain a video-simulation of the same sequence to be used as a preliminary or parallel virtual test of said at least one prosthesis 1 with respect to the testing carried out with the aforementioned articulator robot 90 with mounted the models 20, 30 of said upper and lower dental arches.

With the method described, therefore, and in correspondence with what has already been said at the bottom of the description of the system 100, the dental prosthesis 1 can be checked exactly as if it had been directly applied to the mouth of the subject S, so that all of them can be carried out on it. the adjustments, measurements and modifications necessary to obtain a product directly applicable to subject S, without requiring one or more direct tests on the latter, avoiding further modifications.

From the above description, the advantageous aspects offered by the method in question are absolutely evident, in particular for experts in the sector, such as dental technicians and dentists, effectively transposed on a practical level by means of the system for dynamic testing of dental prostheses which, preliminarily, it allows to detect in a very accurate way the positional relationship between the dental arches of the subject, and then to report them exactly between the models of the same dental arches; the latter, arranged in this way, are mounted in an articulating robot, which is commanded to faithfully replicate all the possible chewing movements of the same subject, so as to be able to verify the behavior of the dental prosthesis/s as well as of the prosthesis as if they were installed in the subject’s mouth.

To this end, the tools for detecting the positional relationship between the dental arches of the subject, provided in the system, have been created with original and innovative characteristics to provide the expected data with the necessary precision.

Another fundamental requirement, which is solved with the tools of the above system, concerns the acquisition of the three-dimensional parameters relating to the personal chewing movements of the recipient of the prosthesis, without which it would be impossible to control the aforementioned articulator robot to faithfully replicate them.

However, it is understood that what has been described above has an exemplary and non-limiting value, therefore any detailed variations that may be necessary for technical and/or functional reasons, are considered from now on to fall within the same protective scope defined by the following claims.

1. Method comprising dynamic testing of dental prostheses, a dental for implantation prosthesis (1) for implantation recipient subject (S), for which a dentition model has been made including a model (20) of an upper dental arch and a model (30) of a lower dental arch, with each of said models (20, 30) obtained starting from respective negative casts (2, 3) of said upper and lower dental arches, said method further comprising the following
a) application to said negative casts (2, 3) of the upper and lower dental arches of relative bases (41) provided with a predetermined external attachment fork (42);
b) assembly of said base (41) with a negative cast (2) of the upper dental arch, by means of the relative attachment fork (42), in an attitude detection device (40);
c) introduction of said base (41) with negative cast (2) of the upper dental arch into the oral cavity of the aforementioned subject (S), with the head (T) of the latter arranged in a predetermined position and with said attitude detection device (40) projecting in a cantilever way outside the mouth;
d) acquisition, by means of said attitude detection device (40), of angular values of inclination of the negative cast (2) of the upper dental arch and therefore of the upper dental arch itself, or of the jaw, of the subject (S);
e) extraction from the oral cavity of the subject of said base (41) with a negative cast (2) of the upper dental arch with adjoining attitude detection device (40);
f) assembly of the base complex (41) with a negative cast (2) of the upper dental arch and the attitude detection device (40) in a manual articulator (50);
g) coupling of the negative cast (2) of the upper dental arch with the respective model (20) of the upper dental arch and the construction of a support (21) of the upper dental arch model (20), with application of filler material (22) between the upper dental arch model (20) and a corresponding bracket (53) of said manual articulator (50);
h) removal from the manual articulator (50) of the base assembly (41) with the negative cast (2) of the upper dental arch and the trim detection device (40) and disassembly of the base assembly with the negative cast (2) of the upper dental arch;
i) repetition of steps b) to h) using the base (41) with a negative cast (3) of the lower dental arch, in order to obtain, on said manual articulator (50), also a support (31) for the lower dental arch model (30);
j) assembly on said manual articulator (50) of an extensible column template (6) for detecting a configuration assumed as a result of a subsequent assembly of the negative casts (2, 3) and models (20, 30) of said upper and lower dental arches;
k) use of the aforementioned extensible column template (6) to record a configuration of an articulator robot (90) in a same way as the detected configuration of the manual articulator (50);
l) assembly on said articulator robot (90), thus recorded, of the aforementioned models (20, 30) of said upper and lower dental arches, having applied at least one dental prosthesis (1) to be tested;
m) acquisition and digitization of a predetermined sequence of shots of personalized chewing movements, on at least three reference axes, by video footage of the subject (S) made with a suitable 3D scanner, with the same subject (S) wearing positional reference means of the upper and lower dental arches, equipped with respective upper (72) and lower (73) markers with at least three detection points (72R, 73R), arranged outside the mouth;
n) digital processing of said shots with a program generator (80), to create a sequence of commands suitable for replicating the personalized chewing movements of said subject (S);
o) actuation of the articulator robot (90) with said sequence of commands, to move the models (20, 30) of said upper and lower dental arches, having applied at least one dental prosthesis (1) to be tested, in perfect replication to the chewing movements of the subject (S) destined to receive the prosthesis (1), so as to be able to evaluate the correctness of dentation of the dental prosthesis (1), so as to identify any need for possible modification.

2. The method according to claim 1, wherein in the distinct phases in which said negative casts (2, 3) of the upper and lower dental arches are introduced into the oral cavity of the subject (S), the head (T) of the subject is placed straight with the gaze turned to a horizon line, and resulting from subsequent relative phases for the acquisition of the angular inclination values of the upper and lower dental arches, or of the maxilla and mandible of the subject (S), horizontal, with the aid of bubble levels (46, 47), a reference tablet (45) provided in said attitude detection device (40), and then a ball joint (44) is locked, also provided in the attitude detection device (40), relative positions of the reference tablet (45) with respect to that of said negative casts (2, 3) is stabilized.

3. The method according to claim 1, wherein for the acquisition and digitization phase of a predetermined sequence of chewing movements, the detection points (72R) of the upper markers (72), associated with the maxilla, are considered the fixed references while the detection (73R) of the lower ones (73), associated with the mandible, are considered the movable references whose displacements are detected in relation to the positions of said fixed references.

4. The method according to claim 1, wherein it is envisaged to: detect the three-dimensional mathematics of said upper and lower dental arch models (20, 30), including the dental prosthesis (1), and load them into a software program of a dental CAD; loading in the same software program of the dental CAD the digitized data of said predetermined sequence of chewing movements, on at least three reference axes, acquired through the recorded video footage of the subject (S) made with a 3D scanner; interface, by means of said software program, said three-dimensional mathematics with the aforementioned digitized data of the sequence of chewing movements, to obtain a video-simulation of the same sequence to be used as a preliminary virtual test, or parallel, of said at least one dental prosthesis (1) compared to the testing carried out with the aforementioned articulator robot (90) with the models (20, 30) of said upper and lower dental arches mounted.

5. A system, for the dynamic testing of dental prostheses, a dental prosthesis (1) among these being intended to be implanted in a recipient subject (S), for which a dentition model has been made including a model (20) of an upper dental arch and a model (30) of the lower dental arch, with each of said models (20, 30) obtained starting from respective negative casts (2, 3) of said upper and lower dental arches, said system (100) comprising:
an attitude detection device (40) in which there are provided: at least two bases (41), each provided with an external attachment fork (42), intended to support said negative casts (2, 3) of the upper dental arches and lower and to be introduced, one at a time, into the oral cavity of the aforementioned subject (S), with the head (T) of the latter arranged in a predetermined position and with said attitude detection device (40) protruding overhang outside the mouth; a block (43), removably associable with one of said bases (41) by means of the relative fork (42), to said block (43) being articulated, by means of a lockable spherical joint (44), a reference tablet (45) on the which are arranged, one orthogonal to the other, two air bubble levels (46, 47) intended to display the reached horizontal position of the same reference board (45), then locked by means of said ball joint (44), so as to stabilize the relative position of the aforementioned reference tablet (45) with respect to that of said negative casts (2, 3);
a manual articulator (50), consisting of a fixed lower platform (51) to which an upper arm (52) is articulated in a lockable manner, arranged at a predetermined distance from said fixed lower platform (51), in said manual articulator (50) the subsequent assembly of the bases (41) being envisaged, with the negative casts (2, 3) of the dental arches, and of the associated block (43) with ball joint (44), to reconstruct, between said fixed lower platform (51) and said upper arm (52) the reciprocal position between the models (20, 30) of the aforementioned upper and lower dental arches which reproduces the position of the respective real dental arches of the aforementioned subject (S);
an extensible column template (6) to acquire the distance and the resulting orientation between the fixed lower platform (51) and the upper arm (52) of said manual articulator (50), corresponding to an initial condition in which said models (20, 30) of the dental arches are mutually in contact;
means (70) for the acquisition and digitization of a predetermined sequence of chewing movements of the aforementioned subject (S), on at least three reference axes, said means comprising a 3D scanner, members (71) for video shooting of the subject (S) and positional reference means of the upper and lower dental arches, provided with respective upper (72) and lower (73) markers with at least three detection points, with said positional reference means provided to be introduced into the oral cavity of the subject, and with said markers (72, 73) arranged externally;
a program generator (80), provided for the digital processing of said video footage of chewing movements, and to create a sequence of commands suitable for replicating the personalized mandibular movements of said subject (S);
a computer-controlled articulator robot (90), designed to support said model (20) of the upper dental arch in a fixed position and to move said model (30) of the lower dental arch, the aforementioned articulator robot (90) being intended to be statically registered, by means of said extensible column template (6), according to said models (20, 30) of the dental arches, as well as suitable to be piloted by a sequence of commands provided by the aforementioned program generator (80), to simulate predetermined chewing movements of said models (20, 30) of upper and lower dental arches, with applied at least one dental prosthesis (1) to be tested, in perfect replication of the mandibular movements of the subject (S) destined to receive the same at least one dental prosthesis (1).

6. The system according to claim 5, wherein a rod (48) intended to be coupled to said ball joint (44) and to be stably interposed, vertically, between said fixed lower platform (51) and the aforementioned upper arm (52), so that the corresponding base (41) and the relative negative cast (2, 3) are oriented towards the inside of said manual articulator (50).

7. The system according to claim 5, wherein said articulator robot (90) comprises a frame (91) from which an upper beam (92) protrudes, able to support in a fixed position said model (20) of the upper dental arch with the relative support (21), and a lower platform (93) to which said model (30) of the lower dental arch is fixed, with the respective support (31), and by the fact that said lower platform (93) is associated with a plurality of linear actuators (94), suitably arranged and oriented, capable of moving the same lower platform (93), as well as the associated model (30) of the lower dental arch, with multiple trajectories according to different planes, said linear actuators (94) being piloted from said sequence of commands supplied by the aforementioned program generator (80).
